(19) United States
(12) Patent Application Publication
(10) Pub. No.: US 2026/0348792 A1
(43) Pub. Date: Nov. 5, 2026

(54) DEVICE FOR THE INTERFEROMETRIC CHECKING OF OPTICAL SURFACES

(71) Applicant: Max-Planck-Gesellschaft zur Förderung der Wissenschaften e.V., München (DE)

(72) Inventors: Klaus MANTEL, Baiersdorf (DE); Maria CHEKHOVA, München (DE)

(21) Appl. No.: 19/102,671

(22) PCT Filed: Aug. 11, 2023
(86) PCT No.: PCT/EP2023/072300

§ 371 Date: Feb. 10, 2025

(30) Foreign Application Priority Data
Aug. 11, 2022 (DE) 10 2022 120 283.6

(51) Int. Cl. G01M 11/02; G01B 9/02; G01B 11/24

(52) U.S. Cl. CPC G01M 11/0271; G01B 9/02039; G01B 11/2441

(57) ABSTRACT

A device for the interferometric examination of optical surfaces includes a light source configured for generating an exposure beam, wherein at least one conversion element, in particular a conversion crystal, is configured to covert the exposure beam into a measuring beam and a reference beam, wherein the device includes a light guiding element, in particular a beam splitter, which is configured for guiding the reference beam into a reference path and the measuring beam into a measuring path of the device wherein the device includes a wavefront adjustment means in the measuring path.

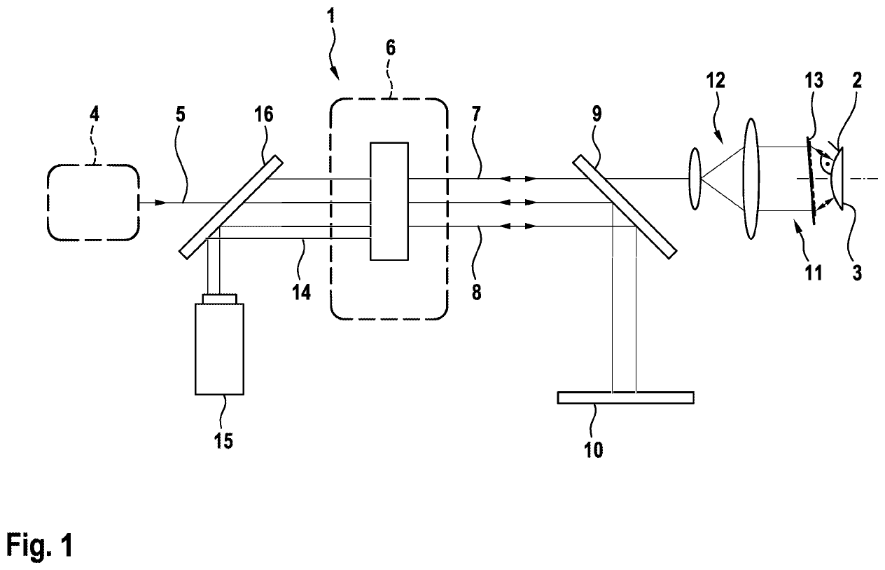

The invention relates to a device for interferometric examination of optical surfaces, comprising a light source configured for generating an exposure beam.

Devices for interferometric examination of optical surfaces are known in principle from the prior art. An interferometric examination of this kind is typically used for measuring optical surfaces or determining deviations of an optical surface, for example a lens surface, from a target shape. The interferometric surface examination functions very successfully when radiation in the visible spectrum is used, wherein applications in what is known as an NIR spectral range (near infrared spectrum) are also possible. Applications in the case of larger wavelengths are significantly more complex, since the sensitivity of the measuring system suffers and required available detectors are less sensitive and significantly more expensive. A further disadvantage is that light sources for this spectral range are usually less developed than corresponding sources in the visible range.

If the optical surface to be examined is an asphere or aspherical, typically a device is used which is configured for examining the optical surface by means of a wavefront adjustment means, in particular with a zero test means in an interferometric zero test, in order to do justice to the greater accuracies of today's methods of manufacturing technology, such as magneto rheological finishing. Since for example the zero test adjusts an incident flat wave to the (known) ideal surface shape of the asphere, only deviations from the ideal target shape in the form of interference fringes are visible for which the entire sensitivity range of the interferometer is available. In this case, the adjustment generally takes place with the aid of diffractive zero elements, which are produced lithographically. However, restrictions of the aspherical shape result in the process. Steep aspheres lead to structure sizes, in the zero element used, that are difficult to achieve in terms of production technology.

Alternatively, aspheres can also be measured using radiation of greater wavelengths, for example radiation in the infrared region of the spectrum, wherein, however, the disadvantages described at the outset with respect to the generation of the radiation and the detection of the signal must be taken into account.

The object of the invention is that of specifying a device for interferometric examination of optical surfaces that is improved in comparison.

The object is achieved by a device having the features of claim 1. The dependent claims relate to advantageous embodiments.

As described at the outset, the invention relates to a device for interferometric examination of optical surfaces. The device comprises a light source which is configured for generating an exposure beam. As explained at the outset, in principle any exposure beams or radiation in any form can be generated as the “exposure beam”, wherein depending on the detector used, and possibly in coordination with the conversion element described below, exposure beams can be selected or the exposure beam and the light source that generates the exposure beam can be selected, in such a way that radiation suitable for the detector is generated. In particular, the exposure beam can be generated in such a way that the radiation that strikes the detector is in a suitable spectrum or spectral range, such that a comparatively less complex detector can be used and a good signal-to-noise ratio can be achieved.

The invention is based on the finding that a conversion element, in particular a conversion crystal, is provided, which is configured for converting the exposure beam into a measuring beam and a reference beam. The conversion element can in principle be configured for generating a measuring beam and a reference beam by interaction, in particular by parametric fluorescence (also “parametric down conversion”, PDC), from the exposure beam, which both have different wavelengths. The device further comprises a (first) light guiding element, for example a beam splitter, which is configured for guiding the reference beam in a reference path and the measuring beam in a measuring path of the device, wherein the device comprises a wavefront adjustment means, in particular a zero test means, in the measuring path. Thus, in principle, the exposure beam is guided to or through the conversion element and is used for converting the exposure beam into a measuring beam and a reference beam based on the mechanism of the conversion element. In particular, a pump beam is used as the exposure beam, which pump beam passes through the conversion element and in the process, as described, generates the measuring beam and the reference beam by parametric fluorescence. The terms “exposure beam” and “pump beam” can thus be used analogously or exchanged correspondingly in the following description.

The procedure of generating a measuring beam and a reference beam by means of PDC, from the exposure beam using a conversion element, for example a conversion crystal, is known in principle in the context of quantum OCT, i.e. a quantum-based optical coherence tomography method. Since such methods, in particular quantum OCT, are already known from the prior art, the details of such methods are not discussed in more detail herein. In the following description, in particular at points in which the conversion element and the conversion into the measuring beam and reference beam or signal beam are described in more detail, if required the necessary details will be discussed.

As described, the device comprises, in addition to the light source and the conversion element which is configured for converting the exposure beam generated or emitted by the light source into the measuring beam and the reference beam, a wavefront adjustment means, for example a zero test means. The wavefront adjustment means is configured for examining the optical surface in the context of an adapted interferometric test. This means in particular that it is not the optical surface in its overall form that is examined but rather the radiation striking the optical surface, in particular the measuring beam, is changed in such a way that the changes made to the measuring beam are adjusted, entirely in the case of a zero test or a zero test means or in general just in part, to the target shape of the optical surface.

The incident radiation can be selected or set as a flat wave and be adjusted to the (known) ideal surface shape of the optical surface of the test item or measurement object by a suitable object in the beam path of the wavefront adjustment means. If the adjustment to the target shape is performed completely, the wavefront adjustment means is referred to as a zero test means, or the wavefront adjustment is referred to as a zero test. As a result, only deviations from the ideal target shape in the form of interference fringes are visible on the detector, for which therefore the entire sensitivity range of the interferometer is available.

In other words, in the case of a perfectly produced optical surface which corresponds to its ideal target shape, in the course of a zero test complete compensation of the change of the measuring beam purposely made in the zero test means is achieved, such that the measuring beam and reference beam do not have any deviations relative to one another. It follows from this that, in the course of the zero test, exclusively deviations of the shape of the optical surface from its target shape are determined, instead of determining the absolute shape of the optical surface. This advantageously makes it possible that the measuring range of the zero test means and thus the measuring range of the device can be used completely for the deviations from the target shape. If, instead of the zero test, a general change deviating from complete compensation is performed, this is understood as general wavefront adjustment.

The device is thus configured for providing an exposure beam using a light source, which beam is converted or divided by means of a conversion element into the measuring beam and the reference beam. The reference beam is guided into the reference path, for example to a reference mirror, and the measuring beam is guided into the measuring path, and thus to the optical surface to be examined, for example an optical measurement object or test item, via a (first) light guiding element, for example a beam splitter. Since a wavefront adjustment means is arranged in the measuring path of the device, the optical surface, i.e. the optical measurement object to be examined, can, as described, be examined.

The wavefront adjustment means can comprise at least one diffractive optical element in order to adjust the incident measuring beam to the optical surface, wherein the diffractive optical element guides the measuring beam onto the measurement object.

As described, the diffractive optical element can be matched to the optical surface to be examined in such a way that, in the case of a perfectly produced measurement object, the changes of the measuring beam introduced by the diffractive optical element are just compensated by the optical surface to be examined, such that the measuring beam reflected on the optical surface and emerging through the wavefront adjustment means just corresponds to the measuring beam incident into the wavefront adjustment means. Deviations of the optical surfaces result in the outgoing measuring beam deviating from the incident measuring beam. The deviations can thus be detected, such that the optical surface can be characterized on the basis of the detected deviations. In other words, the diffractive optical element changes the wavefront of the measuring beam precisely such that in the case of the reflection of the changed measuring beam on the measurement object compensation of the introduced changes takes place, which correspond to the target shape of the test item. Remaining deviations suggest a deviation of the optical surface from the desired target shape.

The splitting or conversion of the exposure beam into the measuring beam and the reference beam in particular means that the measuring beam can be of a wavelength suitable for the optical zero test, and the reference beam can be of a wavelength deviating therefrom, which for example simplifies the detection. As described, in the first case the use of longwave radiation outside the visible spectrum is particularly advantageous, in order to keep the required diffractive optical elements as simple as possible and as uncomplicated to produce as possible. In particular, structure sizes, for example a period, of such diffractive optical elements have to fulfil less strict requirements, and therefore they can be produced in a less complex manner. In the second case, in contrast, visible light is preferred, in order to allow for detection of the signal with little technological outlay and a good signal-to-noise ratio.

The conversion element can in principle be configured for generating a signal beam by interaction, in particular by parametric fluorescence with the measuring, reference and exposure beams returned by the zero test configuration and the reference mirror. The describe signal beam can be of the same wavelength as the reference beam and can, for example by means of a (second) light guiding element, be guided onto the detector, and therefore interfere there with the reflected reference beam. In particular, the information coded in the measuring beam can be transferred to the signal beam by the surface quality of the test item. The (second) light guiding element can in turn be a beam splitter. The measuring beam is, as described, reflected at the optical element to be measured or the optical surface to be examined and guided back to the conversion element. In a corresponding manner, the reference beam is guided by the conversion element into the reference path, where the reference beam is reflected, for example on a flat mirror, and also returned to the conversion element.

The conversion element thus receives the reflections of the measuring beam, the reference beam and the pump beam, such that, based on the parametric fluorescence, a signal beam of the same wavelength as the reference beam can be generated, which is guided via the (second) light guiding element to the detector and is detected there. In particular, the interference pattern generated by the reference beam and signal beam is detected, which contains the information relating to the surface deviations of the test item and can be further processed using conventional methods of optical measuring technology.

As described, a reference beam and a measuring beam are generated by the conversion element. The reference beam and the measuring beam form interlocked photon pairs in the sense of quantum OCT, wherein a photon (usually in the MIR (mid infrared) or even in the THz range) interacts, as the measuring beam, with the measurement object, while the other photon is guided, as the reference beam, into the reference path. In the second passage, the measuring beam (typically in the visible or NIR) transfers its information to a signal beam, which is also generated by PDC but is now of a wavelength in the visible range, and is guided to the detector and superimposed there with a photon of the same wavelength, from the reference beam.

The pairs are generated by the quantum effect of the spontaneous parametric fluorescence in a non-linear interferometer, wherein the photons respectively generated from the exposure beam via PDC are referred to as s- and i-photons. Interference is observed between two s-photons, provided that they share a common i-beam. In the present case, the role of the interfering s- and i-photons is represented by the signal and reference beam and by the measuring beam. This technology is based on the phenomenon of quantum coherence and allows for acquisition by measuring technology in “difficult” spectral ranges (MIR or THz), while the detection takes place in a range suitable for this, in particular in the visible or NIR.

The region of the PDC having high amplification is achieved by strong pumping, typically with the aid of ps-pulses in conversion elements, in particular conversion crystals of a few mm in length. The photon rates of the signal and idler of the twin beams scale exponentially with the pumping rate. Typical values for the parametric amplification extend to an amplification value (gain) G=10, achieved by focusing the pump beam in 2-3 mm long crystals, which leads to an increase in the intake intensity by the factor sinh²(G).

PDC having high amplification is advantageous for non-linear interferometry. It allows for high power on the detector, and therefore it is possible to use conventional detectors in the visible range, without worsening the signal-to-noise ratio.

Thus, in summary, it is advantageously possible to achieve different wavelengths in the measuring beam and in the reference beam. In this case, the measuring beam can in particular be of a different wavelength compared with the signal beam used for interference. The measuring process, i.e. the interaction with the measurement object or the optical surface to be examined, and the detection of the signal on the detector, can thus take place in different wavelengths or spectral ranges. This makes it possible for a respectively suitable spectral range to be selected for the individual processes, specifically detection of the signal and interaction with the measurement object. For the interaction with the measurement object, i.e. for the measuring beam, in particular infrared radiation can be selected, wherein for the detection of the signal or as the reference beam or signal beam a wavelength in the visible spectral range or in the NIR spectral range are selected.

As described, the measuring beam should be of a wavelength that is longwave and thus above the visible spectrum, in particular also above the near infrared spectrum, preferably >3 μm. As described, the interaction with the optical surface to be examined can take place in the infrared range, such that it is possible to reduce the requirements placed on the diffractive optical element of the wavefront adjustment means, which performs the change of the wavefront of the measuring beam, in particular in view of the producibility. In this respect, it has in particular been found that, for the diffraction at the grating of the diffractive optical element, radiation in the infrared range or a longer wavelength range compared with the visible spectrum is advantageous. In this case, in particular a spectral range can be used which is greater than 4 μm, in particular is between 4 and 5 μm.

The reference beam and/or the signal beam can be of a wavelength that deviates from this. The signal beam and/or the reference beam can be of a wavelength in the visible spectrum. In principle, this simplifies the acquisition of the signal or the detection of the signal. For this purpose, simplified detectors, in particular simplified compared with a detector operating in the IR spectral range, can be used. For example, standard CCD or CMOS detectors can be used, and therefore in principle the device is configured in a less complex manner and the detection of the signal, for example with respect to the signal-to-noise ratio, can be improved.

The conversion element can in particular be configured, for example depending on at least one object parameter of an optical element to be examined, to generate the signal beam having a defined number of photons and/or a defined power on a detector. The object parameter of the optical element to be examined or of the optical measurement object which comprises the optical surface to be examined can for example define the intensity that the measurement object can tolerate. Advantageously, the intensity of the measuring beam can be selected such that it can be at the upper end of the range of what the measurement object can tolerate. For example, this can be controlled by the intensity of the pump beam.

As described at the outset, the conversion element can perform the conversion of the exposure beam, for example a pump beam, into a measuring beam and a reference beam, or the conversion element can generate a measuring beam and a reference beam using the pump beam. The conversion element can in particular be configured as a conversion crystal or comprise a conversion crystal of this kind, in particular β-barium borate or lithium niobate. Depending on the mechanism desired or the measuring beam and reference beam that are intended to be generated, different conversion crystals may be expedient for use as the conversion element.

As explained at the outset, the described device in particular makes it possible to examine aspheres or aspherical optical surfaces or aspherical optical elements. In particular, the device can be configured to acquire at least one parameter of optical elements or measurement objects having a numerical aperture of greater than 0.3-0.5, in particular greater than 0.7. The at least one parameter can in particular be a deviation from a target shape. The described optical elements or optical surfaces are characterized by a comparatively large numerical aperture, such that the device can in particular be configured for measuring comparatively steep optical surfaces.

The invention furthermore relates to a method for the interferometric examination of optical surfaces by means of a device, in particular a device described above, wherein the exposure beam is converted into a measuring beam and a reference beam by means of a conversion element, in particular a conversion crystal, illuminated by an exposure beam, wherein the reference beam is conducted into a reference path and the measuring beam is conducted into a measuring path of the device comprising a wavefront adjustment means, in particular a zero test means, and at least one parameter of an optical element, arranged in the measuring path and comprising the optical surface, is determined, in particular based on an interference of a signal beam, generated by the conversion element, with the reference beam.

All the advantages, details and features that have been described with reference to the device can be transferred in their entirety to the method.

The invention will be explained in the following on the basis of an embodiment and with reference to the figures. The figures schematically show a device for interferometric examination of optical surfaces.

The figures show a device 1 for interferometric examination of an optical surface 2 of a measurement object 3 or a test item. The measurement object 3 can in particular be an asphere, i.e. an optical element having an aspherical optical surface 2, for example having a numerical aperture of greater than 0.3-0.5, in particular greater than 0.7. The device 1 comprises a light source 4 which is configured for generating an exposure beam 5, in particular a “pump beam”. In this embodiment, the exposure beam 5 is guided onto a or through a conversion element 6, for example a conversion crystal, in particular made of β-barium borate or lithium niobate.

In the conversion element 6, the exposure beam 5 is converted into a measuring beam 7 and a reference beam 8. In other words, in the conversion element 6 the exposure beam 5 induces the generation of a measuring beam 7 and a reference beam 8. The conversion of the exposure beam 5 into the measuring beam 7 and the reference beam 8 is based on spontaneous parametric fluorescence or “parametric down conversion” (PDC). The reference beam 8 is guided, after the conversion element 6, via a light guiding element 9, for example a beam splitter, onto a reference mirror 10 arranged in a reference arm of the device 1, at which mirror the reference beam 8 is reflected and guided back to the conversion element 6 on the same path.

The measuring beam 7 is guided from the conversion element 6, for example via the light guiding element 9, in a measuring path of the device 1 into a wavefront adjustment means 11, which is configured for example as a zero test means. In this embodiment, the wavefront adjustment means 11 comprises a beam expansion means 12 and a diffractive optical element 13. The diffractive optical element 13 is inclined relative to the optical axis, in order to suppress reflections from the measurement object 3.

The diffractive optical element 13 is produced in coordination with the optical surface 2 of the measurement object 3, such that the diffractive optical element 13 guides the expanded measuring beam 7 to the optical surface 2 in a changed manner. The change of the wavefront which is introduced via the diffractive optical element 13 should be adjusted, in part or entirely, to the shape of the measurement object 3, or compensate this exactly in the case of a zero test. In other words, the measuring beam 7 is guided through the optical element 13 onto the optical surface 2 and reflected at the optical surface 2. If the optical surface 2 is produced according to its target shape, then the changes introduced by the optical surface 2 and the diffractive optical element 13 compensate one another in part or entirely, such that the outgoing measuring beam 7 should ultimately exhibit partial or no changes relative to the incoming measuring beam 7. In the case of a full adjustment, the incoming measuring beam 7 would correspond exactly to the outgoing measuring beam 7 or the reflected measuring beam 7 that is guided back to the conversion element 6 from the measurement object 3.

Deviations of the target shape of the optical surface 2 can thus be identified since they are not compensated by the diffractive optical element 13. In other words, the wavefront adjustment means 11 makes it possible to identify deviations from the target shape of the optical surface 2, such that the device 1 is limited as a whole by the overall sensitivity range to deviations, and does not have to determine the overall form of the optical surface 2.

As descried, the measuring beam 7 is guided from the measurement object 3, in particular the optical surface 2, back to the conversion element 6. In this case, a transmission of the information that is carried in the measuring beam 7 to a signal beam 14 can take place. In other words, the reflected exposure beam 5 and the measuring beam 7 reflected from the optical surface 2 and the reference beam 8 reflected by the reference mirror 10 interact, and thus generate the signal beam 14 which can be guided from the conversion element 6 to a detector 15, in particular reflected at a second light guiding element 16 which can also be a beam splitter.

The signal beam 14 can be guided to the detector 15 together with the reference beam 8 reflected at the reference mirror 10, and thus interfere therewith. Based on the interference pattern on the detector 15, it is thus possible to analyze or to determine the deviations from the target shape of the optical surface 2. In the context of spontaneous parametric fluorescence, a photon pair is generated in which a photo is guided as a measuring beam 7 to the optical surface 2, and thus interacts with the measurement object 3, wherein the other photo can be guided as a reference beam 8 onto the reference mirror 10. As also described, the reflected portion of the measuring beam 7, the exposure beam 5 or “pump beam” and the reflected reference beam 8 again generate a photon pair, in the conversion element 6, one photon of which pair is guided to the detector 15 and the signal beam 14. Between the two photons, i.e. the reference beam 8 and the signal beam 14, interference can be observed on the detector 15, provided that the counterparts are identical, which is the case here.

An interaction of the measuring beam 7 with the signal beam 14 on the detector 15 is therefore not essential. The detector 15 can therefore be oriented exclusively to the radiation or the wavelength of the reference beam 8 or the signal beam 14. This can in particular be in the visible range, and therefore the detector 15 can be configured as a CCD or CMOS sensor, or can comprise such a sensor. This advantageously allows for radiation having a different wavelength from the radiation for the reference beam 8 or the signal beam 14 to be used as the measuring beam 7.

In particular, radiation in the mid infrared range up to the terahertz range can be used as the measuring beam 7, in particular radiation of a wavelength of greater than 3 um, in particular between 4 and 5 um. In contrast, light of a wavelength in the visible spectrum can be used as the signal beam 14 or as the reference beam 8, in order to improve the detection.

### LIST OF REFERENCE SIGNS

1 device
2 optical surface
3 measurement object
4 light source
5 exposure beam
6 conversion element
7 measuring beam
8 reference beam
9 light guiding element
10 reference mirror
11 wavefront adjustment means
12 beam expansion means
13 diffractive optical element
14 signal beam
15 detector
16 light guiding element

1. A device for the interferometric examination of optical surfaces, comprising a light source configured for generating an exposure beam, wherein at least one conversion element is configured to convert the exposure beam into a measuring beam and a reference beam, wherein the device comprises a light guiding element, which is configured for guiding the reference beam into a reference path and the measuring beam into a measuring path of the device, wherein the device comprises a wavefront adjustment means in the measuring path.

2. (The device according to claim 1, wherein the wavefront adjustment means comprises at least one diffractive optical element, wherein the diffractive optical element guides the measuring beam onto the measurement object.

3. The device according to claim 1, wherein the conversion element is configured to generate a signal beam by interaction of the reflected reference beam with the measuring beam reflected at the measurement object.

4. The device according to claim 1, wherein the measuring beam and the reference beam have different wavelengths.

5. The device according to claim 1, wherein the measuring beam has a wavelength above the visible spectrum,.

6. The device according to claim 1, wherein the second signal beam and/or the reference beam has a wavelength in the visible spectrum.

7. The device according to claim 1, wherein the conversion element is configured depending on at least one object parameter of an optical measurement object to be examined, to generate the second signal beam having a defined number of photons and/or a defined power on a detector.

8. The device according to claim 1, wherein the conversion element is configured as a conversion crystal or comprises at least one conversion crystal.

9. The device according to claim 1, wherein the device is configured to acquire at least one parameter of the optical measurement object with a numerical aperture >0.3-0.5.

10. A method for the interferometric examination of optical surfaces by a device according to any of the claim 1, wherein the exposure beam is converted into a measuring beam and a reference beam by means of a conversion element illuminated by an exposure beam, wherein the reference beam is conducted into a reference path and the measuring beam is conducted into a measuring path of the device comprising a wavefront adjustment means and at least one parameter of an optical measurement object, arranged in the measuring path and comprising the optical surface, is determined based on an interference of a second signal beam generated by the conversion element with the reference beam.
